(19) United States
(12) Patent Application Publication
(10) Pub. No.: US 2017/0158801 A1
(43) Pub. Date: Jun. 8, 2017

(54) RIGID POLYURETHANE FOAMS SUITABLE FOR WALL INSULATION

(71) Applicants: Covestro LLC, Pittsburgh, PA (US); Covestro S.A. de C.V., Mexico City (MX)

(72) Inventors: Shawn G. Rider, Harrisville, PA (US); Michael S. Super, Pittsburgh, PA (US); Salvador Mejia Gomez, Mexico City (MX); Carlos Garcia Vital, Mexico City (MX)

(73) Assignees: Covestro LLC; Covestro S.A. de C.V.

(21) Appl. No.: 14/960,722

(22) Filed: Dec. 7, 2015

(51) Int. Cl. C08G 18/08; C08J 9/12; C08J 9/14; C08G 18/18; C08G 18/76; C08G 18/66

(52) U.S. Cl. CPC C08G 18/14; C08G 18/7664; C08G 18/6677; C08J 9/146; C08G 18/1808; C08G 18/1816; C08J 9/127; C08J 9/125; C08J 2203/10; C08J 2203/142; C08J 2205/052; C08J 2205/10; C08J 2375/08; C08G 2101/0025

(57) ABSTRACT

Rigid polyurethane foams are made by reacting an organic polyisocyanate with an isocyanate-reactive composition which includes a polyol, a blowing agent blend of hydrofluorocarbons, a urethane-forming catalyst, a polyether-modified polysiloxane, and water. The blowing agent blend includes a C₄ polyfluorohydrocarbon and a C₃ polyfluorohydrocarbon. The rigid polyurethane foams exhibit improved adhesion to facer substrates and excellent thermal conductivity, compressive strength, and dimensional stability.

### TECHNICAL FIELD

This invention pertains generally to blends of blowing agents useful for blown polyurethane foam systems. More specifically, the invention pertains to polyurethane foam-forming compositions comprising blends of hydrofluorocarbons which are useful for rigid polyurethane foams and composites made therefrom.

### BACKGROUND

Rigid polyurethane foams are widely known and used in numerous industries. These foams are produced by reacting an appropriate polyisocyanate and an isocyanate-reactive compound, usually a polyol, in the presence of a blowing agent. One use of such foams is as a thermal insulation medium in the construction of refrigerated storage devices. The thermal insulating properties of closed-cell rigid foams are dependent upon a number of factors including, the average cell size and the thermal conductivity of the contents of the cells, Chlorofluorocarbons (CFC's) were typically used as blowing agents to produce these foams because of their exceptionally low vapor thermal conductivity. However, CFC's are now known to contribute to the depletion of ozone in the stratosphere and, as a result, mandates have been issued which prohibit their use.

Initially, the most promising alternatives to CFC's appeared to be hydrogen-containing chlorofluorocarbons (HCFC's). While HCFC's, such as HCFC 141b, have been used as alternatives to CFC's, they have also been found to have some ozone-depletion potential. There is, therefore, mounting pressure to find substitutes for HCFC's as well as CFC's.

Alternative blowing agents such as hydrofluorocarbons (HFC's) and hydrocarbons (HC's), which do not pose a threat to the ozone layer as they do not contain chlorine, are currently favored. Neither of these two classes of materials, however, have all the attributes of “ideal” blowing agents. That is, although HFC's and HC's are environmentally more acceptable than CFC's and HCFC's, they are frequently inferior in certain physical properties such as solubility, flammability, and boiling point. For example, many of the HFC's and HC's are gases at room temperature which makes them difficult to handle, and many have flashpoints below room temperature, thus requiring changes to the foam processing methods and equipment and/or increased risks in their handling and use as blowing agents.

As such, there remains an unfulfilled need in the art to develop polyurethane foam systems which do not utilize HCFC's, but which produce foams with a good balance of properties: acceptable flammability, good compressive strength and excellent adhesion to substrates, and which require few changes to the existing foam-forming processes and equipment.

### SUMMARY

Embodiments disclosed herein are directed to blowing agent blends, and foam-forming compositions for use in forming rigid polyurethane foams, which eliminate the use of HCFC's yet provide rigid polyurethane foams having excellent adhesion to facer substrates and a low density, all while maintaining acceptable or improved R-values, compressive strength, and dimensional stability. Thus, the present invention provides a foam-forming composition comprising a blowing agent which is a blend of HFC's.

These and other embodiments which will be apparent to those skilled in the art are accomplished by reacting an organic polyisocyanate component with an isocyanate-reactive component in the presence of a blowing agent blend, a urethane-forming catalyst, a polyether-modified polysiloxane and water. The isocyanate-reactive component may include a polyol comprising at least one polyether polyol having a hydroxy functionality of 3.0 or greater and a number average molecular weight of less than 2000 g/mol. The blowing agent blend may include a C₄ polyfluorohydrocarbon and a C₃ polyfluorohydrocarbon, such as a blend of pentafluorobutane and heptafluoropropane. Additionally, the composition may further comprise a tertiary amine urethane-forming catalyst which improves adhesion of the polyurethane foam to facer substrates.

### DETAILED DESCRIPTION

It is to be understood that certain descriptions of the disclosed embodiments have been simplified to illustrate only those steps, elements, features, and aspects that are relevant to a clear understanding of the disclosed embodiments, while eliminating, for purposes of clarity, other steps, elements, features, and aspects. Persons having ordinary skill in the art, upon considering the present description of the disclosed embodiments, will recognize that other steps, elements, and/or features may be desirable in a particular implementation or application of the disclosed embodiments. However, because such other steps, elements, and/or features may be readily ascertained by persons having ordinary skill upon considering the present description of the disclosed embodiments, and are not necessary for a complete understanding of the disclosed embodiments, a description of such steps, elements, and/or features is not provided herein. As such, it is to be understood that the description set forth herein is merely exemplary and illustrative of the disclosed embodiments and is not intended to limit the scope of the invention as defined solely by the claims.

Throughout this description and in the appended claims, use of the singular includes the plural and plural encompasses singular, unless specifically stated otherwise. For example, although reference is made herein to “an” organic polyisocyanate, “a” polyol, “a” blowing agent, “a” catalyst, and “a” polyether-modified polysiloxane, one or more of any of these components and/or any other components described herein can be used.

Other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited herein is intended to include all lower numerical limitations subsumed therein and any minimum numerical limitation recited herein is intended to include all higher numerical limitations subsumed therein. Accordingly, Applicant(s) reserves the right to amend the present disclosure, including the claims, to expressly recite any sub-range subsumed within the ranges expressly recited herein. All such ranges are intended to be inherently disclosed herein such that amending to expressly recite any such sub-ranges would comply with the requirements of 35 U.S.C. §112 and 35 U.S.C. §132(a).

The term “functionality” is used herein to refer to the number of reactive hydroxyl groups, —OH, that are attached to the polyol molecule. In the production of polyurethane foams, the hydroxyl groups react with isocyanate groups, —NCO, that are attached to the isocyanate compound. The term “hydroxyl number” refers to the number of reactive hydroxyl groups available for reaction, and is expressed as the number of milligrams of potassium hydroxide equivalent to the hydroxyl content of one gram of the polyol (ASTM D4274-88). The term “equivalent weight” refers to the weight of a compound divided by its valence. For a polyol, the equivalent weight is the weight of the polyol that will combine with an isocyanate group, and may be calculated by dividing the molecular weight of the polyol by its functionality. The equivalent weight of a polyol may also be calculated by dividing 56,100 by the hydroxyl number of the polyol−Equivalent Weight (g/eq)=(56.1×1000)/OH number.

It has been unexpectedly found that the use of a blend of HFC's as a blowing agent in a foam-forming composition is particularly advantageous because rigid polyurethane foams having excellent performance characteristics can be obtained. Further, the use of a tertiary amine urethane-forming catalyst as an adhesion promoter has been unexpectedly found to provide polyurethane foams having greater adhesion to facer substrates in a composite article.

The present invention provides a foam-forming composition which when reacted forms a rigid polyurethane foam. The composition comprises (A) an organic polyisocyanate and (B) an isocyanate-reactive composition. The isocyanate-reactive composition may comprise (a) a polyol comprising at least one polyether polyol having a hydroxy functionality of 3.0 or greater, (b) a blowing agent blend, (c) a urethane-forming catalyst, (d) a polyether-modified polysiloxane, and (e) water.

Any of the known organic isocyanates, modified isocyanates or isocyanate-terminated prepolymers made from any of the known organic isocyanates may be used in the foam-forming composition of the present invention. Suitable organic isocyanates include aromatic, aliphatic, and cycloaliphatic poly isocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclohexane diisocyanate, isomers of hexahydro-toluene diisocyanate, isophorone diisocyanate, dicyclo-hexylmethane diisocyanates, 1,5-naphthylene diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and polyisocyanates such as 4,4′-dimethyl-diphenylmethane-2,2′,5,5′-tetraisocyanate and the polymethylene polyphenyl-polyisocyanates.

Undistilled or crude polyisocyanates may also be used in the foam-forming composition of the present invention. The crude toluene diisocyanate obtained by phosgenating a mixture of toluene diamines and the crude diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat No. 3,215,652.

Modified isocyanates are obtained by chemical reaction of diisocyanates and/or polyisocyanates. Modified isocyanates useful in the practice of the present invention include isocyanates containing ester groups, urea groups, biuret groups, allophanate groups, carbodiimide groups, isocyanurate groups, uretdione groups and/or urethane groups. Examples of modified isocyanates include prepolymers containing NCO groups and having an NCO content of from 25 to 35 weight percent, such as from 29 to 34 weight percent, and particularly those based on polyether polyols or polyester polyols and diphenylmethane diisocyanate. Processes for the production of these prepolymers are known in the art.

In embodiments of the foam-forming composition of the present invention, useful polyisocyanates include methylene-bridged polyphenyl polyisocyanates and prepolymers of methylene-bridged polyphenyl polyisocyanates having an average functionality of from 1.8 to 3.5, such as from 2.0 to 3.1, isocyanate moieties per molecule and an NCO content of from 25 to 32 weight percent, due to their ability to cross-link the polyurethane.

Any of the known organic compounds containing at least three isocyanate reactive moieties per molecule may be employed as part of the isocyanate-reactive component of the foam-forming composition of the present invention. In certain embodiments, the isocyanate-reactive compounds may be polyols or mixtures of polyols having average functionalities of at least 3, such as from 3 to 8, or from 3 to 6, isocyanate-reactive hydrogen atoms.

The hydroxyl number and molecular weight of the polyols can vary according to the desired property of the cellular foam. In general, polyols useful in the foam-forming composition of the present invention may have hydroxyl numbers which range from 200 to 650 mg KOH/g, such as from 200 to 550 mg KOH/g, and number average molecular weights which are less than 3,000 g/mol, such as less than 2,000 g/mol, or even less than 1000 g/mol.

In certain embodiments, the isocyanate-reactive component may comprise polyether polyols. Polyether polyols can be prepared by reacting suitable starters with one or more alkylene oxides, such as ethylene, propylene and/or butylene oxide. The polyether polyols may have functionalities of between 3 and 6 and average equivalent weights of between 70 and 300 g/eq.

Suitable starters useful for preparing the polyether polyols of the present invention include organic dicarboxylic acids (e.g., succinic acid, adipic acid, phthalic acid and terephthalic acid), polyhydric alcohols (e.g., ethylene glycol, propylene glycol, glycerin, trimethylolpropane, pentaerythritol, sorbitol, sucrose and bisphenol A), alkanolamines (e.g., ethanolamine, diethanolamine, N-methyl- and N-ethyl-ethanolamine, N-methyl- and N-ethyl-diethanolamine, and triethanolamine), aliphatic and aromatic amines (e.g., ethylenediamine, diethylenetriamine, triethylenetetramine, 1,3-propylenediamine, 1,3- or 1,4-butylenediamine, 1,2-, 1,3-, 1,4-, 1,5- and 1,6-hexamethylenediamine, phenylenediamine, o-toluenediamine, m-toluenediamine, methylenedianiline, polymethylenedianiline, 2,3-, 2,4- and 2,6-tolylenediamine, toluene diamine, and 4,4′-, 2,4′- and 2,2′-diamino-diphenylmethane which may be substituted with a mono- or dialkyl group), and ammonia.

Polyvalent alcohols may also be suitable as starter molecules, such as divalent, trivalent and/or more valent alcohols, (e.g., ethanediol, propanediol-1,2 and propanediol-1,3, diethylene glycol, dipropylene glycol, butanediol-1,4, hexanediol-1,6, and glycerine).

Non-limiting examples of commercially-available polyether polyols useful in accordance with the invention include those commercially available under the product name MULTRANOL (available from Covestro, LLC).

Polyester polyols may be prepared from, for example, an organic dicarboxylic acid having 2 to 12 carbon atoms, such as an aliphatic dicarboxylic acid having 4 to 6 carbon atoms, and a polyvalent alcohol, such as a diol or triol having 2 to 12 carbon atoms. Examples of the dicarboxylic acid are succinic acid, glutaric acid, adipic acid, suberic acid, azelaic acid, sebacic acid, decanedicarboxylic acid, maleic acid, fumaric acid, phthalic acid, isophthalic acid and terephthalic acid. Instead of a free dicarboxylic acid, a corresponding dicarboxylic acid derivative such as a dicarboxylic acid monoester or diester prepared by esterification with an alcohol having 1 to 4 carbon atoms or dicarboxylic anhydride can be used.

Exemplary polyvalent alcohols include, for example, ethanediol, diethylene glycol, 1,2- or 1,3-propanediol, dipropylene glycol, 1,4-butanediol, 1,5-pentanediol, 1,6-hexanediol, 1,10-decanediol, glycerine and trimethylolpropane. Furthermore, a polyester polyol produced from a lactone such as ε-caprolactone or a hydroxycarboxylic acid such as a Ω-hydroxycaproic acid can be used.

Either one polyol or a blend of two or more polyols may be useful as part of the isocyanate-reactive component in the foam-forming composition of the present invention.

The isocyanate and isocyanate-reactive materials may be used in quantities such that the equivalent ratio of isocyanate groups to isocyanate-reactive groups is from 1.0 to 2.0, such as from 1.05 to 1.75, or from 1.10 to 1.50.

Any of the known HFC blowing agents, and any of their known isomers, may be employed as the blowing agent blend in the foam-forming composition of the present invention. Exemplary HFC blowing agents include C₃-C₄ polyfluorohydrocarbons, such as C₃-C₄ polyfluoroalkanes and polyfluoroalkenes, and any of the known isomers of C₃-C₄polyfluoroalkanes and polyfluoroalkenes.

The C₃-C₄ polyfluoroalkanes useful in the present invention include those represented by the formula:

CX₃—CY₂—R (I)

in which each X independently represents hydrogen or fluorine, each Y independently represents hydrogen, fluorine or CF₃, and R represents H, F, CH₂F, CHF₂, CH₃, CF₃, CF₂—CH₃, CF₂CH₂F, or CH₂—CH₃, wherein at least two fluorine atoms are present and the total number of carbon atoms is from 3 to 4.

Any of the known isomers of C₃ and (polyfluoroalkanes may be used in the foam-forming composition of the present invention such as, for example, 1,1,2,2,3-pentafluoropropane (HFC-245ca); 1,1,2,3,3-pentafluoropropane (HFC-245ea); 1,1,1,3,3-pentafluoropropane (HFC-245fa): 2,2,4,4-tetrafluorobutane; 1,1,1,3,3-pentafluorobutane (HFC-365mfc); 1,1,1,3,3-pentafluoro-n-butane; 1,1,1,3,3,3-hexafluoropropane; 1,1,1,3,3,3-hexafluoro-2-methylpropane; 1,1,1,3,3,4-hexafluorobutane; 1,1,1,4,4,4-hexafluoro-butane (HFC-365mffm); 1,1,1,2,3,3,3-heptafluoropropane (HFC-227ea); and mixtures thereof.

Mixtures or blends of C₃ and C₄ polyfluoroalkanes are useful. An exemplary blowing agent blend which may find utility in the foam-forming composition of the present invention includes mixtures of pentafluorobutane and heptafluoropropane, or any of their known isomers. For example, in certain embodiments, the mixtures may include 1,1,1,3,3-pentafluorobutane (HFC-365mfc) and 1,1,1,2,3,3,3-heptafluoropropane (HFC-227ea).

In certain embodiments, the blowing agent blend comprises from 80 to 90, such as from 86 to 88, weight percent of (i) C₄ polyfluoroalkane, such as 1,1,1,3,3-pentafluorobutane (HFC 365mfc), and from 10 to 20, such as from 12 to 14, weight percent of (ii) C₃ polyfluoroalkane, such as 1,1,1,2,3,3,3-heptafluoropropane (HFC 227ea), based on the total weight of the blowing agent blend.

The blowing agent blend is generally included in the isocyanate-reactive composition mixture in amounts below the flashpoint as determined by ASTM D93: Pensky-Martens Closed Cup Method. That is, the blowing agent blend can become flammable when blended with the isocyanate-reactive composition in amounts that are too great, or when mixed with polyols for which the blend is poorly soluble. As such, when the blowing agent blend includes irons 80 to 90 weight percent C₄ polyfluoroalkane and from 10 to 20 weight percent C₃ polyfluoroalkane, based on the total weight of the blowing agent blend, the blend may be included in the isocyanate reactive composition (B) in an amount of up to 16 weight percent, based on the total weight of the foam formulation.

Water can also be included in the loam-forming mixture. When water is included, it is generally included in the isocyanate reactive composition (B) in an amount of greater than 0.5 weight percent, such as from 1.0 to 4.0 weight percent, or from 1.5 to 3.5weight percent, based upon the total weight of the isocyanate reactive component (B), Generally, one molecule of water reacts with two isocyanate groups to form a urea and carbon dioxide gas.

One or more urethane-forming catalysts may be present in the foam-forming composition of the present invention. A wide variety of materials are known to catalyze polyurethane forming reactions, including tertiary amines, tertiary phosphines, various metal chelates, acid metal salts, strong bases, various metal alcoholates and phenolates, and metal salts of organic acids. In various embodiments of the present invention, the urethane-forming catalysts include organotin catalysts and tertiary amine catalysts, which may be used singly or in some combination. For example, a combination of at least one tertiary amine “gelling” catalyst, which strongly promotes the reaction of an alcohol group with an isocyanate to form the urethane, and at least one tertiary amine “blowing” catalyst, which strongly promotes the reaction of an isocyanate group with a water molecule to form carbon dioxide, may be used as the urethane-forming catalyst of the present invention.

Specific examples of suitable tertiary amine catalysts include: pentamethyldiethylenetriamme (PMDETA), N,N-dimethylcyclohexylamine (DMCHA), N,N′,N″-dimethylaminopropyl-hexahydrotriazine, tetramethylethylenediamine, tetramethyl-butylene diamine and dimethylethanolamine. In certain embodiments, useful tertiary amine catalysts include Pentamethyldiethyienetriamine (PMDETA), N,N′,N″-dimethylaminopropyl-hexahydrotriazine, and N,N-dimethylcyclohexylamine (DMCHA). Specific examples of suitable organometallic catalysts include dibutyltin dilaurate, dibutylin diacetate, stannous octoate, potassium octoate, potassium acetate, and potassium lactate.

It has been unexpectedly found that certain of the above indicated tertiary amine catalysts improve adhesion of the rigid polyurethane foam to facer substrates. Urethane-forming catalysts which improve adhesion include at least the blowing catalyst pentamethyldiethyienetriamine (PMDETA). Thus, mixtures of tertiary amine urethane-forming catalysts which may measurably increase the rate of reaction of the polyisocyanate, such as a gelling catalyst, and improve adhesion to the facer substrate, such as a blowing catalyst, are useful. Exemplary mixtures include mixtures of N,N-dimethylcyclohexylamine (DMCHA) and pentamethyldiethyienetriamine (PMDETA).

Urethane-forming catalysts may be used at from 0.01 to 3 weight percent, or 0.3 to 1.0 weight percent, based on the total weight of the isocyanate reactive composition (B). The urethane-forming catalyst may include a mixture of a tertiary amine gelling catalyst used at from 0.1 to 1.0 weight percent, or from 0.3 to 0.7 weight percent, and a blowing catalyst at from 0.01 to 0.3 weight percent, or 0.05 to 0.15 weight percent, based on the total weight of the isocyanate reactive composition (B).

When preparing polyurethane-based foams, it is generally helpful to employ a minor amount of a surfactant to stabilize the foaming reaction mixture until it obtains rigidity. Such surfactants advantageously comprise an organosilicon compound such as polysiloxane-polyalkyene-block copolymers, such as a polyether-modified polysiloxane. Other useful surfactants include polyethylene glycol ethers of long chain alcohols, tertiary amine or alkanolamine salts of long chain alkyl acid sulfate esters, alkylsulfonic esters, or alkylarylsulfonic acids. Such surfactants are employed in amounts sufficient to stabilize the foaming reaction mixture against collapse and the formation of large and uneven cells. Typically, 0.2 to 5.0 weight percent of the surfactant, based on the total weight of the isocyanate reactive composition (B), is sufficient for this purpose.

Additional materials which may optionally he included in the foam-forming compositions of the present invention include: chain extenders, crosslinking agents, pigments, colorants, fillers, antioxidants, flame retardants, and stabilizers.

Exemplary flame retardants useful in the foam-forming composition of the present invention include, but are not limited to, reactive bromine based compounds known to be used in polyurethane chemistry and chlorinated phosphate esters, including but not limited to, tri(2-chloroethyl)phosphate (TECP), tri(1,3-dichloro-2-propyl)phosphate, tri(1-chloro-2-propyl)phosphate (TCPP) and dimethyl propyl phosphate (DMPP).

The present invention also provides a process for the production of rigid polyurethane foams with a blend of HFC blowing agents. In the process of the present invention (A) an organic isocyanate is reacted with (B) an isocyanate-reactive composition that includes (a) a polyol comprising at least one polyether polyol having a hydroxy functionality of 3.0 or greater, (b) an HFC blowing agent blend, such as a blend of a C₃ polyfluorohydrocarbon and a C₄ polyfluorohydrocarbon, (c) a urethane-forming catalyst, (d) a polyether-modified polysiloxane, (e) water, and (f) optionally other additives selected from the group comprising flame retardants, chain extenders, crosslinking agents, pigments, colorants, fillers, antioxidants, and stabilizers. In certain embodiments of the process, the blowing agent blend may comprise a pentafluoro-butane and a heptafluoro-propane such as, for example, 1,1,1,3,3-pentafluoro-butane (“HFC-365mfc”) and 1,1,1,2,3,3,3-heptafluoro-propane (“HFC-227ea”), respectively.

The process described may be employed to produce rigid polyurethane foams and composite products comprising such foams. In certain embodiments, the polyol of the isocyanate-reactive composition (B) may be reacted with an organic polyisocyanate (A) in the presence of the blowing agent blend, urethane-forming catalyst, polyether-modified polysiloxane surfactant, water and optionally, a flame retardant, and other additives, fillers, etc. The rigid foams of the present invention may he prepared in a one-shot process by reacting all of the ingredients together at once, or the foams may be prepared by the so-called quasi-prepolymer method.

In the one-shot process where foaming is carried out using foam machines, the polyol, urethane-forming catalyst, surfactant, blowing agent, water and optional additives may be introduced separately to the mixing head where they are combined with the polyisocyanate to give the polyurethane-forming mixture. The mixture may be poured or injected into a suitable container or molded as required. For use of machines with a limited number of component lines into the mixing head, a premix of all the components except the polyisocyanate can he advantageously employed.

It is convenient in many applications to provide the components for polyurethane production in pre-blended formulations based on each of the primary polyisocyanate and isocyanate-reactive components. In particular, many reaction systems employ a polyisocyanate-reactive composition which contains the major additives such as the blowing agent in addition to the isocyanate reactive component or components. According to the two-component method (component A: polyisocyanate; and component B: isocyanate reactive composition which includes the polyol, blowing agent, catalyst, polysiloxane, and water), the components may be mixed at a temperature of 5 to 50° C., such as 15 to 35° C., poured into a mold having the temperature adjusted to within a range of from 20 to 70° C., such as 35 to 60° C., and then foamed to give a rigid polyurethane foam. This simplifies the metering and mixing of the reacting components which form the polyurethane foam-forming mixture.

Therefore, the present invention also provides an isocyanate-reactive composition comprising (a) a polyol comprising at least one polyether polyol having a hydroxy functionality of 3.0 or greater, (b) an HFC blowing agent blend, such as a blend of a C₃ polyfluorohydrocarbon and a C₄ polyfluorohydrocarbon, (c) a urethane-forming catalyst, (d) a polyether-modified polysiloxane, (e) water, and (f) optionally other additives selected from the group comprising flame retardants, chain extenders, crosslinking agents, pigments, colorants, fillers, antioxidants, flame retardants, and stabilizers. In certain embodiments of the process, the blowing agent blend may comprise a pentafluoro-butane and a heptafluoro-propane such as, for example, 1,1,1,3,3-pentafluoro-butane (“HFC-365mfc”) and 1,1,1,2,3,3,3-heptafluoro-propane (“HFC-227ea”), respectively.

Alternatively, the rigid polyurethane foams may also be prepared by the so-called “quasi prepolymer” method. In this method, a portion of the polyol component is reacted in the absence of the urethane-forming catalysts with the polyisocyanate component in proportion so as to provide from 10 percent to 30 percent of free isocyanate groups in the reaction product based on the prepolymer. To prepare foam, the remaining portion of the polyol is added and the components are allowed to react together in the presence of the urethane-forming catalysts and other appropriate additives such as the blowing agent, polyether-modified polysiloxane, etc. Other additives may be added to either the isocyanate prepolymer or remaining polyol or both prior to the mixing of the components, whereby at the end of the reaction, a rigid polyurethane foam is provided.

Furthermore, the rigid polyurethane foam can be prepared in a batch or continuous process by the one-shot or quasi-prepolymer methods using any well-known foaming apparatus. The rigid polyurethane foam may be produced in the form of slab stock, moldings, cavity fillings, sprayed foam, frothed foam or laminates with other materials such as hardboard, plasterboard, plastics, paper or metal as facer substrates.

The compositions and processes of the present invention provide a substantially closed-cell rigid polyurethane foam. As indicated above, the blowing agent blends of the present invention have no flashpoint when included at less than 16 weight percent, based on the total weight percent of the isocyanate-reactive component. Furthermore, the rigid polyurethane foams of the present invention have excellent compressive strength and adhesion to facer substrates.

The compressive strength of the rigid polyurethane foams produced according to various embodiments of the present invention is typically in the range of from 95 to 120KPa (perpendicular to the direction of foam flow) and 140 to 200 KPa (parallel to the direction of foam flow). As used herein, the term “compressive strength” refers to a numerical physical property value of a foam that is determined from a point on a stress versus deformation (i.e., deflection) curve at 10 percent deformation, as measured in accordance with ASTM D1621. Externally applied stress deforms the cell structure of foams. The compressive strength is expressed in terms of stress/unit area of the foam at which stress is applied.

Furthermore, foams produced according to the present invention have acceptable adhesion to substrates. The adhesive properties of rigid polyurethane foams are determined by measuring tensile adhesion strength of the foam to a desired substrate. ASTM D1623 is an acceptable standard for measuring tensile adhesion of rigid polyurethane foams. In certain embodiments, the rigid polyurethane foams produced according to the present invention may have a tensile adhesion strength greater than 250 KPa as measured by ASTM D1623 when adhered to Versitek VR2 plastic liner. Moreover, the rigid polyurethane foams of the present invention typically have a peak peel strength of greater than 2 lb-f/in and an average peel strength of greater than 1 lb-f/in according to ASTM D429: 90° peel test when adhered to Versitek VR2 plastic liner.

For closed-cell insulating foams, the object is to retain the blowing agent in the cells to maintain a low thermal conductivity of the insulating material, i.e., the rigid polyurethane foam. Thus, a high closed-cell content in the foam is desirable. Foams produced according to various embodiments of the present invention have more than 80 percent, typically more than 85 percent, or more than 88 percent closed-cell content as measured according to ASTM D6226. Furthermore, the thermal conductivity of foams produced according to various embodiments of the present invention indicates that the foams have acceptable insulating properties. Typical thermal conductivity measured at 35° F. (2° C.) ranges from 0.135 to 0.145 BTU-in/h-ft2-° F., and measured at 75° F. (24° C.) ranges from 0.155to 0.165 BTU-in/h-ft2-° F., for foam from the core of 2-inch to 4-inch thick panels, as measured according to ASTM C_{518.}

The invention also relates to the use of rigid polyurethane foams according to the invention for thermal insulation. That is, the rigid polyurethane foams of the present invention may find use as an insulating material in refrigeration apparatuses since the combination of good thermal insulation, high strength, good blowing agent solubility and rapid curing (short mold dwell time) is particularly appropriate here. The rigid foams according to the invention can be used, for example, as an intermediate layer in composite elements or for filling hollow spaces of refrigerators and freezers, or refrigerated trailers. The inventive foams may also find use in the construction industry or for thermal insulation of long-distance heating pipes and containers.

As such, the present invention also provides a composite article comprising a rigid polyurethane foam as disclosed herein sandwiched between one or more facer substrates. In certain embodiments, the facer substrate may be plastic, paper, wood, or metal material. For example, in certain embodiments, the composite article may be a refrigeration apparatus such as a refrigerator, freezer, or cooler. In certain embodiments, the refrigeration apparatus may be a trailer, and the composite article may include the polyurethane foams produced according to the present invention in sandwich composites for trailer side-walls.

Having thus described our invention, the following examples are given as being illustrative thereof. All parts and percentages given in these examples are parts by weight and percentages by weight, unless otherwise indicated.

### EXAMPLES

The present compositions were developed to provide polyurethane foam systems that do not utilize CFC's or HCFC's but produce foams with a good balance of properties (e.g., acceptable compressive strength and good adhesion to facer substrates), and which require few changes to the existing foam-forming processes and equipment. Historically, HCFC-141b has been favored for production of closed-cell polyurethane foams because it has a high boiling point (32° C.), is a liquid under atmospheric conditions, is not flammable, and has low thermal conductivity which provides a foam suitable for insulation purposes.

While HFC-245fa has been employed as an alternative to the HCFC blowing agents, it has a relatively low boiling point (15° C.) which leads to a high vapor pressure that often requires upgrading plant equipment to accommodate the associated higher pressures. Other HFC's also exhibit low boiling points and may even be gases under atmospheric conditions (HFC-227ea, boiling point −16° C.), or may be flammable (HFC-365mfc, boiling point 40° C.). The present inventors have unexpectedly found that certain mixtures or blends of HFC's provide a composition which is non-flammable and has a suitably high boiling point that few or no changes to the existing foam-forming processes and equipment are required. Blowing agent blends suitable for use in the foam-forming compositions of the present invention include a mixture of (i) a C₄ polyfluorohydrocarbon, and (ii) a C₃ polyfluorohydrocarbon.

Further, the present inventors have formulated a polyol system in which the blowing agent blends are soluble, thus further reducing the risks of flammability. Such a polyol system may include a polyol comprising at least one polyether polyol having a hydroxy functionality of 3.0 or greater and a number average molecular weight of less than 2000, such as less than 1000. Specifically, it was unexpectedly found that polyol C improved the solubility of the blowing agent blends of the present invention. Thus, an exemplary polyol may include polyol C as listed below. In certain embodiments, an exemplary poly includes a mixture of polyol A, polyol B, and polyol C as listed below.

The materials used in the Examples given below were as follows:

| | |
|---|---|
| POLYOL A: | A sucrose-based polyether polyol, which is commercially available |
| | under the tradename Multranol ® 4030 from Covestro, LLC. This |
| | polyol has an OH number of 380 mg KOH/g, a number average |
| | molecular weight of 857, and a hydroxyl functionality of 5.8. |
| POLYOL B: | A glycerine-based triol, which is commercially available under the |
| | tradename Multranol ® 9158 from Covestro, LLC. This polyol has an |
| | OH number of 470 mg KOH/g, a number average molecular weight of |
| | 358, and a hydroxyl functionality of 3.0. |
| POLYOL C: | A glycerine-based triol. This polyol has an OH number of 250 mg |
| | KOH/g, a number average molecular weight of 673, and a hydroxyl |
| | functionality of 3.0. |
| POLYOL D: | A mixture of Multranol ® 4030 from Covestro, LLC (sucrose-based |
| | polyether polyol), Multranol ® 9158 from Covestro, LLC (glycerine- |
| | based triol), STEPANPOL ® PS-2502A from Stepan Company (a |
| | modified aromatic polyester polyol), and glycerol. |
| SURFACTANT | A polysiloxane-polyether-copolymer commercially available from |
| A: | Goldschmidt Chemical Corporation under the tradename Tegostab ® |
| | B-8465. |
| CATALYST A: | A tertiary amine catalyst, N,N-dimethylcyclohexylamine, commercially |
| | available from Air Products and Chemicals, Inc. under the tradename |
| | Polycat ®-8. |
| CATALYST B: | A tertiary amine catalyst, pentamethyldiethylenetriamine, commercially |
| | available from Air Products and Chemicals, Inc. under the tradename |
| | Polycat ®-5. |
| ISOCYANATE: | Mondur MR ® isocyanate, a polymethylene polyphenyl polyisocyanate |
| | that is commercially available from Bayer Corporation having an |
| | isocyanate content of 31.5 percent. |
| HFC-365mfc | 1,1,1,3,3-pentafluorobutane |
| HFC-227ea | 1,1,1,2,3,3,3-heptafluoropropane |
| HFC-245fa | 1,1,1,3,3-pentafluoropropane |
| HCFC-141b | 1,1-dichloro-1-fluoroethane |
| FLAME | Chlorinated phosphate ester: tri(1-chloro-2-propyl)phosphate (TCPP) |
| RETARDANT: | |

Various blowing agent blends according to the present invention (see Table 1) were formulated and flashpoint tested in a polyol of the present invention (mixture of polyol A, polyol B, and polyol C as listed above) according to the ASTM D93: Pensky-Martin closed cup method. Blowing agent blend A (see Table 1) was found to be flammable at every loading weight percent tested (loading weight percent is the weight percent of the blowing agent blend based on the total weight of the polyol+blowing agent blend). Blowing agent blend B showed no flashpoint in the polyol at up to 16 loading weight percent (0-16weight percent), whereas blowing agent blend C had no flashpoint in the narrow window of 19 to 25 loading weight percent. Thus, blowing agent blend B would be safe for use at or below 16 loading weight percent, whereas blowing agent blend C may become flammable if blowing agent losses occur which bring the total loading weight percent below 19.

TABLE 1

| Blowing | HFC-365mfc | HFC-227ea | Boiling point |
|---|---|---|---|
| agent blend | (wt %) | (wt %) | (° C.) |
| A | 100 | 0 | 40 |
| B | 87 | 13 | 24 |
| C | 93 | 7 | 30 |

As indicated above, although HFC-245fa does have several of the optimal attributes previously observed for HCFC blowing agents, it has a relatively low boiling point (15° C.) which leads to a high vapor pressure that necessitates certain changes to the manner in which it is shipped and the equipment that is used for producing foam. Vapor pressures were measured for the blowing agent blend B as follows: the polyol (mixture of polyol A, polyol B, and polyol C) and blowing agent blend (5.16 weight percent with respect to the blowing agent plus polyol) were blended and placed into a pressure vessel equipped with an agitator and a pressure gauge. The mixture was then cooled to below 10° C. and allowed to equilibrate while agitating. The head space gas, having either positive or negative pressure, was vented to zero the pressure gauge. This blend was then slowly warmed and the vapor pressure and temperature were periodically recorded. Results are reported in Table 2. At all temperatures measured, the vapor pressure for the blowing agent blend B remained below the working pressure of a standard 16-gauge drum (24 psig).

TABLE 2

| Temperature | Pressure |
|---|---|
| (° C.) | (PSIG) |
| 10 | 0.2 |
| 15 | 2.2 |
| 20 | 3.6 |
| 25 | 4.7 |
| 30 | 6.0 |
| 35 | 7.5 |
| 40 | 10.2 |
| 45 | 12.6 |
| 50 | 15.0 |
| 55 | 18.1 |
| 60 | 21.0 |

The foam-forming compositions used in the various Examples are set forth in Table 3 below. Various properties of the compositions and foams produced therefrom using the formulations of the Examples are set forth in Tables 4 and 5. Examples 1 and 2 are comparative examples, while Examples 3-9 comprise the foam-forming compositions of the present invention. Example 1 is included for comparative purposes only, and is mixed according to the prior art formulation currently used in the industry and not according to the inventive formulations disclosed herein.

TABLE 3

| | Example | | | | | | | | |
|---|---|---|---|---|---|---|---|---|---|
| (wt. percent) | 1^{‡} | 2 | 3 | 4 | 5 | 6 | 7 | 8 | 9 |
| Blowing agent | | | | | | | | | |
| B (from Table 1) | — | — | 11.26 | 14.00 | 17.00 | — | — | — | — |
| C (from Table 1) | — | — | — | — | — | 11.25 | 14.00 | 17.00 | 11.27 |
| HCFC-141b | 25.72 | — | — | — | — | — | — | — | — |
| HFC-245fa | — | 11.10 | — | — | — | — | — | — | — |
| Polyol A | — | 30.72 | 27.08 | 26.15 | 25.24 | 27.05 | 26.15 | 25.24 | 27.10 |
| Polyol B | — | 15.37 | 13.54 | 13.05 | 12.60 | 13.53 | 13.05 | 12.60 | 13.56 |
| Polyol C | — | 39.01 | 34.39 | 33.30 | 32.15 | 34.46 | 33.30 | 32.15 | 34.43 |
| Polyol D | 68.37 | — | — | — | — | — | — | — | — |
| Surfactant | 0.78 | 2.47 | 2.17 | 2.20 | 2.20 | 2.17 | 2.20 | 2.20 | 2.17 |
| Catalyst A | 0.92 | — | 0.69 | 0.80 | 0.90 | 0.69 | 0.80 | 0.90 | 0.49 |
| Catalyst B | — | 0.11 | — | — | — | — | — | — | 0.10 |
| Flame Rtd | 3.59 | 8.96 | 7.90 | 8.00 | 8.00 | 7.89 | 8.00 | 8.00 | 7.91 |
| Water | 0.61 | 3.36 | 2.96 | 2.50 | 1.90 | 2.96 | 2.50 | 1.90 | 2.96 |
| Total isocyanate | 100 | 100 | 100 | 100 | 100 | 100 | 100 | 100 | 100 |
| reactive | | | | | | | | | |
| composition | | | | | | | | | |
| Isocyanate | 130.0 | 133.3 | 118.4 | 109.0 | 96.4 | 118.3 | 109.0 | 96.4 | 118.5 |
| NCO:OH index | 1.143 | 1.143 | 1.143 | 1.150 | 1.148 | 1.143 | 1.150 | 1.148 | 1.143 |

^{‡}For comparative Example 1 only - Silicone surfactant: Tegostab B-8421.

For each of the Examples, the polyols, catalysts, surfactant, blowing agent, water and isocyanate were combined and reacted in the amounts indicated in Table 3. All foams were prepared using a Hennecke HK-2500 high-pressure foam machine. The liquid output was maintained at a constant 20° C. at 5000 grams/second with a pour pressure of 150bar. The minimum fill density was determined from foam panels poured into a temperature controlled mold (40° C.) having dimensions—28 feet by 102 inches by 3 inches with several obstructions in the flow path. The mold was first left open at the top and over-filled to determine minimum fill density by cutting the sample down to known dimensions and determining the mass. After the minimum fill density was determined, the mold was clamped closed and packed to a density of 15 percent over the minimum fill density. The foam was sandwiched between one aluminum facer and one plastic facer. Foams were held in the mold at 40° C. for 25 to 30 minutes before de-molding. Density for each of the inventive foams was typically between 2.10 and 2.20 lb./ft3, measured according to ASTM D1622.

As illustrated in Table 4, foams produced with the inventive formulation of Example 3 demonstrated a compressive strength which was better than the compressive strength of foams formed using HFC-245fa (comparative Example 2) or the industry standard HCFC-141b (comparative Example 1). Furthermore, the inventive formulations of Examples 3-9 produced foams with R-Values comparable to the comparative Examples 1 and 2, measured according to ASTM C₅₁₈, and improved dimensional stability over the comparative examples, measured according to ASTM D2126.

TABLE 4

| | Example | | | | | | | |
|---|---|---|---|---|---|---|---|---|
| | 1 | 2 | 3 | 4 | 5 | 6 | 7 | 8 |
| blowing agent at mix | 13.70 | 4.55 | 5.16 | 6.70 | 8.66 | 5.16 | 6.70 | 8.66 |
| head (wt. %) | | | | | | | | |
| water in polyol side | 0.82 | 3.33 | 3.33 | 2.91 | 2.29 | 3.33 | 2.91 | 2.29 |
| (wt. %) | | | | | | | | |
| TC^{†} at 35° F. | 0.125 | 0.136 | 0.143 | 0.143 | 0.148 | 0.137 | 0.140 | 0.143 |
| TC^{†} at 75° F. | 0.129 | 0.155 | 0.162 | 0.160 | 0.162 | 0.155 | 0.157 | 0.158 |
| R-Value^{‡} at 35° F. | 8.0 | 7.4 | 7.0 | 7.0 | 6.8 | 7.3 | 7.1 | 7.0 |
| R-Value^{‡} at 75° F. | 7.8 | 6.5 | 6.2 | 6.3 | 6.2 | 6.5 | 6.4 | 6.3 |
| % Close cell content | 87.7 | 89.9 | 87.9 | 88.5 | 87.1 | 90.3 | 89.7 | 88.6 |
| Compressive strength | 55 | 87 | 119 | — | — | 88 | — | — |
| at 10% yield (kPa) - | | | | | | | | |
| Perpendicular | | | | | | | | |
| Dimensional Stability | 1.85 | −1.70 | −1.05 | −0.80 | −0.65 | — | −1.15 | 0.20 |
| (% vol. change after 7 | | | | | | | | |
| days at 70° C.) | | | | | | | | |

^{†}TC—Thermal Conductivity (BTU-in/h-ft²-° F.);
^{‡}R-value (h-ft²-° F./BTU-in)

Overall, foams formed using the inventive compositions of Examples 3-8demonstrated excellent insulative properties (Thermal conductivity and R-value; high percent closed cell content), and excellent stability (dimensional stability and compressive strength). Furthermore, the results shown in Table 4 indicate that far less blowing agent is required to produce these foams when using the inventive blends (blowing agent blend B—Examples 3-5; blowing agent blend C—Examples 6-8) than when using the prior art blowing agents (comparative Examples 1 and 2; HCFC-141b and HFC-245fa, respectively). Each of the improved properties—dimensional stability and compressive strength—were found to be improved at every weight percent tested (weight percent of the blowing agent relative to the total weight of the isocyanate reactive composition (as listed in Table 3) for the foam-forming composition (as listed in Table 4)). Therefore, the inventive blowing agent blends may be included in the foam-forming compositions of the present invention at 16 weight percent or less, such as 12 weight percent or less, or 9 weight percent or less, or even 6 weight percent or less, based on the total weight of the foam-forming composition.

TABLE 5

| | Example: | | | |
|---|---|---|---|---|
| | 10 | 11 | 12 | 13 |
| Blowing agent B (pbw) | 8.61 | 8.61 | 8.61 | 8.61 |
| Polyol A | 28.40 | 28.40 | 28.40 | 28.40 |
| Polyol B | 14.20 | 14.20 | 14.20 | 14.20 |
| Polyol C | 36.17 | 36.17 | 36.17 | 36.17 |
| Catalyst A | 0.77 | 0.77 | 0.77 | 0.77 |
| Flame Retardant | 7.59 | 7.59 | 7.59 | 7.59 |
| Water | 2.27 | 2.27 | 2.27 | 2.27 |
| Tegostab B-8497 | 2.09 | — | — | — |
| Tegostab B-8484 | — | 2.09 | — | — |
| Tegostab B-8485 | — | — | 2.09 | — |
| Tegostab B-8465 | — | — | — | 2.09 |
| Total isocyanate reactive | 100 | 100 | 100 | 100 |
| composition | | | | |

Foams formed using the inventive compositions of the present invention were also optimized for surface defects, such as voids, and for adhesion to the facer substrates. Various surfactants were tested for their ability to produce foams having reduced surface defects. Test formulations are listed in Table 5. Qualitative analysis of foams formed from the composition of Example 10 which uses the surfactant Tegostab B-8497, an end-capped surfactant, showed a foam with few surface defects but which had reduced adhesion to the facer substrate. The OH-terminated surfactants Tegostab B-8484, Tegostab B-8485, and Tegostab B-8465 used in Examples 11-13, respectively, all demonstrated improved adhesion to the facer substrate, but with small increases in the amount of surface defects over the Example 10 formulation. Thus, an OH-capped surfactant, such as a polyether-modified polysiloxane, may be useful in the foam-forming compositions of the present invention, showing a good balance of improved adhesion to facer substrates and reduced surface defects.

Additionally, the present inventors discovered that addition of a tertiary amine catalyst further improved adhesion of foams formed using compositions of the present invention to facer substrates. Initial adhesion testing demonstrated that addition of the tertiary amine pentamethyldiethylenetriamine, normally only used as a blowing catalyst, improved adhesion of the inventive foams to facer substrates. As illustrated in Table 5, while foams produced with the inventive formulations of Example 3 had lower average peel strength than the comparative Examples 1 and 2, inclusion of the tertiary amine in Example 9 improved the average peel strength and peak peel strength to plastic facer substrates (Versitek Facer).

TABLE 6

| | Example: | | | |
|---|---|---|---|---|
| | 1 | 2 | 3 | 9 |
| blowing agent (pbw) | 13.7 | 4.55 | 5.16 | 6.70 |
| water in polyol side (pbw) | 0.82 | 3.33 | 3.33 | 2.91 |
| Tensile Adhesion Strength (kPa) | 158 | — | 304 | 289 |
| Average peel strength (lb.-f/in) | 1.25 | 1.25 | 0.92 | 1.31 |
| Peek peel strength (lb.-f/in) | 1.79 | 1.86 | 1.67 | 2.30 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A polyurethane foam-forming composition comprising:
(A) an organic polyisocyanate; and
(B) an isocyanate-reactive composition comprising:
(a) a polyol comprising at least one polyether polyol having a hydroxy functionality of 3.0 or greater and a molecular weight of less than 2000,
(b) a blowing agent blend comprising (i) from 80 to 90 weight percent of a C₄ polyfluorohydrocarbon, and (ii) from 10 to 20 weight percent of a C₃ polyfluorohydrocarbon, based on the total weight of the blowing agent blend,
(c) a urethane-forming catalyst,
(d) a poly ether-modified polysiloxane, and
(e) water,
wherein the isocyanate-reactive composition comprises 16 weight percent or less of the blowing agent blend based on the total weight of the isocyanate-reactive composition.

2. The composition of claim 1, wherein the blowing agent blend has no flashpoint, as determined by ASTM D93: Pensky-Martens Closed Cup Method, when the blowing agent blend is present in an amount of at up to 16 weight percent based on the total weight percent of the isocyanate-reactive composition.

3. The composition of claim 1, comprising a blowing agent comprising pentamethyldiethylenetriamine.

4. The composition of claim 1, wherein the urethane-forming catalyst comprises N,N-dimethylcyclohexylamine.

5. (canceled)

6. The composition of claim 1, wherein the blowing agent blend comprises (i) from 86 to 88 weight percent 1,1,1,3,3-pentafluorobutane (HFC 365mfc) and (ii) from 12 to 14 weight percent 1,1,1,2,3,3,3-heptofluoropropane (HFC 227ea), based on the total weight of the blowing agent blend.

7. (canceled)

8. The composition of claim 1, wherein the organic polyisocyanate comprises a polymeric diphenylmethane diisocyanate.

9. The composition of claim 1, wherein the at least one polyether polyol has a hydroxyl number within the range of 200 to 550 mg KOH/g.

10. A rigid polyurethane foam formed from the composition of claim 1, wherein the foam has an average tensile adhesion strength to Versitek VR2 plastic liner according to ASTM D1623 of greater than 250 Kpa.

11. A rigid polyurethane foam formed from the composition of claim 1, wherein the foam has a peak peel strength to Versitek VR2 plastic liner according to ASTM D429: 90° peel strength test of greater than 2 lb/in.

12. A process for preparing a rigid polyurethane foam sandwiched between facer substrates, the process comprising:
(I) pushing a foam-forming reaction mixture into a closed cavity having one or more facer substrates, wherein the foam-forming reaction mixture comprises:
(A) an organic polyisocyanate, and
(B) an isocyanate reactive component comprising:
(a) a polyol comprising at least one polyether polyol having a hydroxy functionality of 3.0 or greater and a molecular weight of less than 2000,
(b) a blowing agent blend comprising (i) a C₄ polyfluorohydrocarbon, and (ii) a C₃ polyfluorohydrocarbon.
(c) a urethane-forming catalyst.
(d) a polyether-modified polysiloxane, and
(e) water, and
(II) allowing the foam-forming reaction mixture to cure to form a rigid polyurethane foam sandwiched between facer substrates.

13. The process of claim 12, wherein the rigid polyurethane foam has an average tensile adhesion strength to the one or more facer substrates according to ASTM D1623 of greater than 250 Kpa.

14. The process of claim 12, wherein the rigid polyurethane foam has a peak peel strength to the facer substrate according to ASTM D429: 90° peel strength test of greater than 2 lb/in.

15. The process of claim 12, wherein the blowing agent blend comprises from 86 to 88 weight percent 1,1,1,3,3-pentafluorobutane and from 12 to 14 weight percent 1,1,1,2,3,3,3-heptafluoropropane. based on the total weight of the blowing agent blend.

16. The process of claim 12, wherein the blowing agent blend has no flashpoint, as determined by ASTM D93 Pensky-Martens Closed Cup Method, when the blowing agent blend is present in an amount of up to 16 weight percent based on the total weight percent of the isocyanate reactive component.

17. A rigid polyurethane loam composite formed by the process of claim 12, wherein the rigid polyurethane foam has an average tensile adhesion strength to the one or more facer substrates according to ASTM D1623 of greater than 250 Kpa.

18. A rigid polyurethane foam comprising the reaction product of:
(a) an organic polyisocyanate; and
(b) an isocyanate-reactive composition comprising:
(i) a polyol comprising at least one polyether polyol having a hydroxy functionality of 3.0 or greater and a molecular weight of less than 2000;
(ii) a blowing agent blend comprising (i) from 80 to 90 weight percent of a pentafluorobutane and (ii) front 10 to 20 weight percent of a heptafluoropropane, based on the total weight of the blowing agent blend;
(iii) a urethane-forming catalyst;
(iv) a polyether-modified polysiloxane; and
(v) water,
wherein the rigid polyurethane foam has an average tensile adhesion strength to a facer substrate according to ASTM D1623 of greater than 250 Kpa, and
wherein the isocyanate-reactive composition comprises 16 weight percent or less of the blowing agent blend based on the total weight of the isocyanate-reactive composition and wherein the blowing agent blend is present in an amount such that the rigid polyurethane foam has a thermal conductivity measured at 75 F of from 0.155 to 0.165 BTU-in/h-ft2-° F. for foam from the core of a 2-inch to 4-inch thick panel, as measured according to ASTM C518.

19-20. (canceled)

21. The polyurethane foam-forming composition of claim 1, wherein the water is present in an amount of 1.0 to 4.0 weight percent, based on the total weight of the isocyanate-reactive composition.

22. The polyurethane foam forming composition of claim 1, wherein the catalyst is present in an amount of 0.01 to 1.0 weight percent, based on the total weight of the isocyanate-reactive composition.

23. The polyurethane foam-forming composition of claim 1, with the proviso that the isocyanate-reactive composition does not include a polyester polyol.

24. The process of claim 12, wherein the blowing agent blend comprises (i) from 80 to 90 weight percent of a C₄ polyfluorohydrocarbon, and (ii) from 10 to 20 weight percent of a C₃ polyfluorohydrocarbon, based on the total weight of the blowing agent blend.

25. The process of claim 24, wherein the isocyanate reactive component comprises 16 weight percent or less of the blowing agent blend based on the total weight of the isocyanate-reactive composition.

26. The process of claim 25, wherein the water is present in an amount of 1.0 to 4.0 weight percent, based on the total weight of the isocyanate reactive component.

27. The process of claim 25, wherein the catalyst is present in an amount of 0.01 to 1.0 weight percent, based on the total weight of the isocyanate reactive component.

28. The process of claim 25, with the proviso that the isocyanate reactive component does not include a polyester polyol.

29. The process of claim 25, wherein the blowing agent blend is present in an amount such that the rigid polyurethane foam has a thermal conductivity measured at 75° F. of from 0.155 to 0.165 BTU-in/h-ft2-° F. for foam from the core of a 2-inch to 4-inch thick panel, as measured according to ASTM G518.

30. The process of chum 25, wherein the rigid polyurethane foam has a density of between 2.10 and 2.20 lb/ft³, measured according to ASTM D1622.

31. The process of claim 25, wherein the facer substrate comprises plastic.

32. The rigid polyurethane foam of claim 18, wherein the water is present in an amount of 1.0 to 4.0 weight percent, based on the total weight of the isocyanate reactive component.

33. The rigid polyurethane foam of claim 18, wherein the catalyst is present in an amount of 0.01 to 1.0 weight percent, based on the total weight of the isocyanate reactive component.

34. The rigid polyurethane foam of claim 18, with the proviso that the isocyanate reactive component docs not include a polyester polyol.

35. The rigid poly methane foam of claim 18, wherein the rigid polyurethane foam has a density of between 2.10 and 2.20 lb/ft3, measured according to ASTM D1622.
